(19) United States
(12) Patent Application Publication
(10) Pub. No.: US 2017/0235662 A1
(43) Pub. Date: Aug. 17, 2017

(54) SOFTWARE APPLICATION QUALITY ASSESSMENT

(71) Applicant: CA, Inc., Islandia, NY (US)

(72) Inventor: Renee L. Leask, Aubrey, TX (US)

(21) Appl. No.: 15/046,139

(22) Filed: Feb. 17, 2016

(51) Int. Cl. G06F 11/36

(52) U.S. Cl. CPC G06F 11/3612

(57) ABSTRACT

First data is accessed describing a plurality of different functional aspects of a particular software application. The first data is received from multiple different sources. Second data is accessed describing a plurality of different non-functional aspects of the particular software application, the second data received from multiple different sources. A plurality of functional scores for the particular software application is derived based on the plurality of functional aspects. A plurality of non-functional scores for the particular software application is derived based on the plurality of non-functional aspects. A quality score for the particular software application is calculated from the plurality of functional scores and the plurality of non-functional scores.

### BACKGROUND

The present disclosure relates in general to the field of computer systems analysis, and more specifically, to determining computer software system quality.

Software application and service providers typically provide technical support in connection with the products they offer. Support “tickets” can be offered in connection with each technical support issue reported by a consumer of the application or service. These tickets can be tracked by the software provider to identify recurring issues with the software, as well as recurring solutions that can be utilized to develop standardized responses to particular types of issues. In modern software, continuous development and delivery processes have become more popular, resulting in software providers building, testing, and releasing software and new versions of their software faster and more frequently. While this approach helps reduce the cost, time, and risk of delivering changes by allowing for more incremental updates to applications in production, it can be difficult for support to keep up with these changes and potential additional issues that result (unintentionally) from these incremental changes. Additionally, the overall quality of a software product can also change in response to these incremental changes.

### BRIEF SUMMARY

According to one aspect of the present disclosure, first data is accessed, which describes a plurality of different functional aspects of a particular software application. The first data can be received from multiple different sources. Second data can be accessed describing a plurality of different non-functional aspects of the particular software application, the second data is received from multiple different sources. A plurality of functional scores for the particular software application can be derived based on the plurality of functional aspects. Likewise, a plurality of non-functional scores for the particular software application can be derived based on the plurality of non-functional aspects. A quality score for the particular software application can be calculated from the plurality of functional scores and the plurality of non-functional scores.

### BRIEF DESCRIPTION OF THE DRAWINGS

FIG. 1 is a simplified schematic diagram of an example computing system including an example quality assessment system in accordance with at least one embodiment;

FIG. 2 is a simplified block diagram of an example computing system including an example quality assessment system in accordance with at least one embodiment;

FIG. 3 is a simplified block diagram of an example quality score generation in accordance with at least one embodiment;

FIGS. 4A-4F are screenshots of example graphical user interfaces provided in connection with quality scores and data of an example quality assessment system in accordance with at least one embodiment; and

FIG. 5 is a simplified flowchart illustrating an example technique for determining quality scores for applications using an example quality assessment system in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

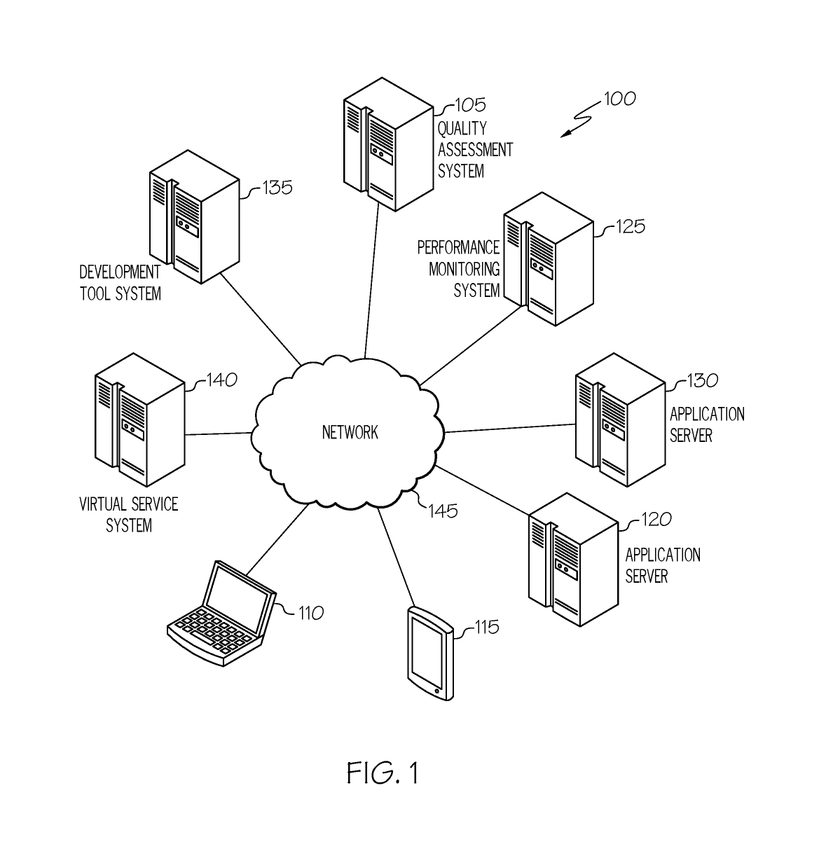

Referring now to FIG. 1, a simplified block diagram is shown illustrating an example computing system 100 including an application quality assessment system 105, capable of generating application quality scores that consider both functional metrics (relating directly to and measuring an application's functional performance during operation (i.e., does the application function as it was designed to or do flaws or faults manifest during operation)) and non-functional metrics (e.g., measuring non-functional characteristics of the application which do not directly pertain to its operation, are tangential to the application's main functionality, and/or characteristics that are observable even when the application is not operating). Metrics can themselves, be scores of varying (i.e., functional and non-functional) aspects of a given software application and can be generated by human users (e.g., using user devices 110, 115) or machine-generated or -derived (e.g., by one or more performance monitoring systems (e.g., 120)). The quality assessment system 105 can generate a quality score for each of several different applications, such as applications hosted by servers 125, 130 and applications such as testing and other software development applications and services (hosted by development tool system 135) and service virtualization application and services (hosted by virtual service system 140), among other examples. In some implementations, an instance of an application or service (e.g., hosted by servers 120, 125, 130, 135, 140) can be provided to multiple different customers, or clients, who consume an instance of the service (e.g., over one or more local or wide area networks (e.g., 145)). Quality scores generated by the quality assessment system 105 can, in such instances, generate multiple customer-specific quality scores for a given software application or service (referred to herein collectively as “application”), each score reflecting details and configuration of each application instance consumed by each respective customer according to the preferences and infrastructure of the respective customer's own system and priorities, among other example features.

In some implementations, a quality assessment server 105 can generate data, which can be rendered (e.g., at a user device (e.g., 110, 115) including a display) to present graphical representations of quality scores it generates. In some cases, such graphical representations can be presented in a dashboard of development and operations (“DevOps”) software development tools and platforms, allowing real-time quality scores and changes to these scores (based on received metrics) to be communicated to software development teams developing and improving (e.g., through continuous development or delivery paradigms) the various applications for which the quality assessment server generates quality scores, among other uses.

In general, “servers,” “clients,” “computing devices,” “network elements,” “hosts,” “system-type system entities,” “user devices,” and “systems” (e.g., 105, 110, 115, 120, 125, 130, 135, 140, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 125, 130, 135, 140, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a quality assessment system 105 or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Traditionally, software application quality has been examined purely from a functional perspective. For instance, how many defects does a software application, how often does the software application throw an error or crash during runtime, how often does an application fail to load, how quickly can transactions of the application be completed on a compatible machine, among other functional measures. However, quality, as observed by customers reflects a more nuanced, user-centric, and sometimes subjective assessment of the subject application. Such subjective metrics have not been married with purely functional metrics to formulate a global quality score that better reflects the quality as experienced by an application's users. As a result, DevOps personnel and tools are likewise typically tuned exclusively to functional metrics. However, even when functional trouble spots are quickly and objectively resolved, the improvement in quality (as observed by the customer-users of the application) is not always improved as effectively.

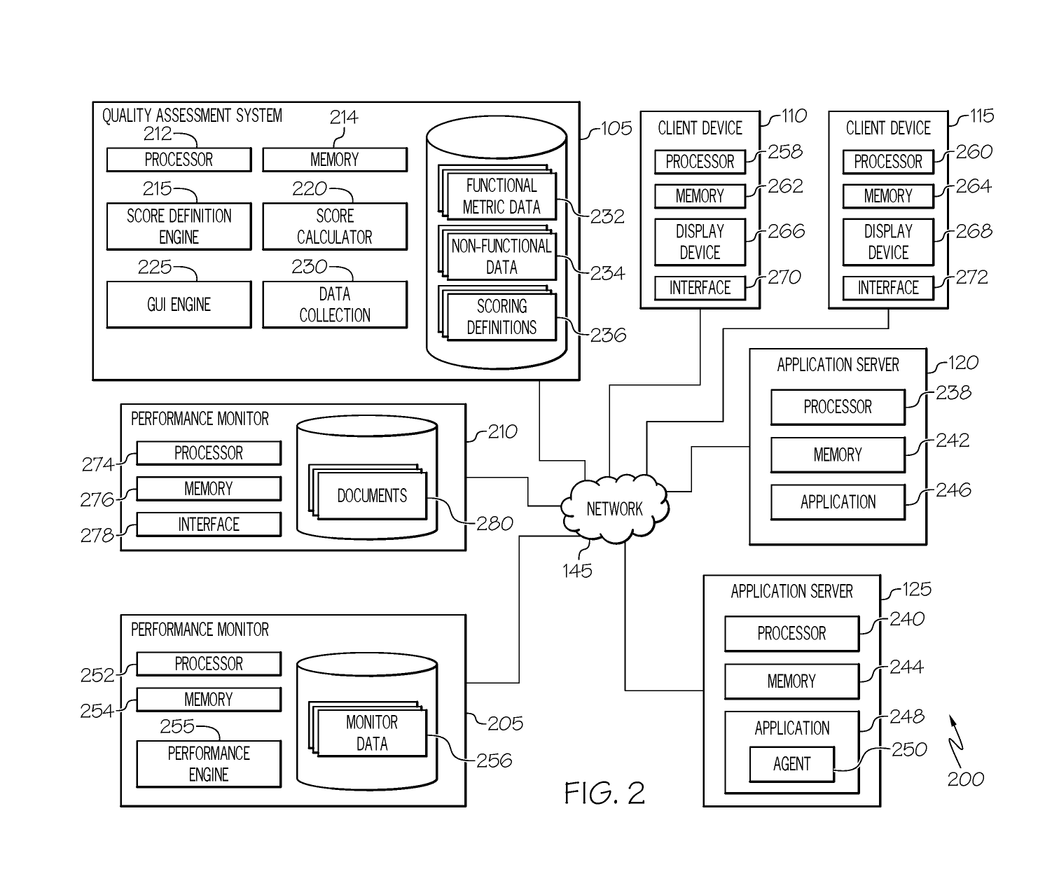

At least some of the systems described in the present disclosure, such as the systems of FIGS. 1 and 2, can include functionality that, in some cases, at least partially remedy or otherwise address at least some of the above-discussed deficiencies and issues, as well as others not explicitly described herein. For instance, as introduced above, a quality assessment system can be provided that adapts quality assessment and improvement practices to yield higher quality, customer focused quality measurements, which can then be translated into bringing similarly high performing and customer-tuned products to market and doing so more quickly. For instance, by developing and generating more complete software application quality assessment scores, which focus, for example, on a more complete and holistic view of quality, development teams can identify and respond to opportunities to further improve their software application products and development processes. For instance, an improved quality assessment score can be generated and quality assessment platform implemented that identifies cross-functional opportunities that provide quality data, systematically solicits this information on a regular basis, accumulates and analyzes quality data in a consolidated manner, and supports processes and alerts to promote higher quality, among other example features.

Turning to the example of FIG. 2, a simplified block diagram 200 is shown illustrating an example environment 200 including example implementations of a quality assessment system 105, user devices 110, 115, application servers 120, 125, performance monitor 205, and data source 210. The systems 105, 110, 115, 120, 125, 205, 210, etc. can interact, for instance, over one or more networks 145. In one example implementation, a quality assessment system 105 can include one or more processor devices (e.g., 212 and one or more memory elements (e.g., 214) for use in executing one or more components, tools, or modules, or engines, such as a score definition engine 215, score calculator 220, graphical user interface (GUI) engine 225, and data collection engine 230, among other potential tools and components including combinations or further compartmentalization of the foregoing. In some implementations, quality assessment system 105 can be implemented as multiple different physical or logical systems including, for example, varying combinations of the foregoing components and tools (e.g., 215, 220, 225, 230) and accompanying data (e.g., 232, 234, 236, etc.), among other implementations.

In one implementation, a quality assessment system 105 can include a score definition engine 215, executable to manage scoring definitions 236 utilized by one or more score calculators 220 to generate quality scores and sub-scores for an example application (e.g., 246, 248). In one example, a default set of scoring definitions can be pre-defined for each of multiple sub-scores. The sub-scores can include multiple scores for non-functional aspects of and multiple scores for functional aspects of applications. In some cases, the default set of scoring definitions can be a set of scoring definitions 236 that can apply to multiple different applications. Additional sets of scoring definitions 236 can be provided that are specific to aspects of a particular application or a particular operating environment (e.g., operating system, host computing platform, etc.). One of the score definitions 236 can be embodied as data defining an algorithm for an overall quality score. The algorithm for the overall quality score can take, as inputs, the scores of each of the multiple functional and non-functional scores derived according to corresponding scoring definitions. Each of the scoring definitions can be embodied as data (e.g., 236) maintained by the quality assessment system 105.

In addition to default and application-specific scoring definitions 236 (which can be utilized to calculate corresponding quality scores and sub-scores), user or customer-specific scoring definitions 236 can also be maintained and utilized by the quality assessment system 105. In some implementations, score definition engine 215 can include functionality to permit users (e.g., through user devices 110, 115) to modify and customize scoring definitions to be used for scoring quality at a particular system. Accordingly, the appropriate set of scoring definitions can be mapped to each respective system and/or customer, such that the score calculator accesses and utilizes the correct scoring definition to generate corresponding quality scores.

A score calculator (e.g., 220) can include machine-executable logic to perform scoring algorithms defined in scoring definitions 236 utilizing corresponding functional metric data (e.g., 232) describing functional aspects of an application and corresponding non-functional metric data (e.g., 234) describing non-functional aspects of an application. A score calculator 220, in some implementations, can further include logic to identify the appropriate subset of functional and non-functional metric data (232, 234) and scoring definitions 236 that correspond to a particular one of a multitude of different applications (e.g., 246, 248) for which the quality assessment system 105 is to derive quality scores. In instances where user-customized scoring definitions are supported, the score calculator 220 can additionally identify those scoring definitions that map to a particular instance, account, or deployment of a particular software application (e.g., where multiple scoring definitions exists corresponding to each of the multiple instances of the particular application).

As noted above, the score calculator 220, to generate an overall quality score for a particular application (or instance of an application) can generate sub-scores upon which the overall quality score is generated. For instance, one or more sub-scores can be generated from functional data 232 to score particular functional characteristics and performance of the applications and additional sub-scores can be generated from non-functional data 234 to score non-functional characteristics of the application. These scores can be combined, in some implementations, to calculate the overall quality score for the application. Further, these sub-scores can also provide insights into quality, albeit at a finer level of granularity than the overall quality score. Indeed, GUIs can be generated (utilizing GUI engine 225) to allow users to view and assess both the overall quality score and sub-scores for one or more different applications. Scores can be calculated and updated in real-time. For instance, as data (e.g., 232, 234) describing functional or non-functional aspects of a particular application are received, the score calculator 220 can re-calculate corresponding sub-scores and the overall quality score of the application to reflect the most up-to-date information collected at the quality assessment system (e.g., using data collection module 230). In some implementations, more recently received metric data can be weighted more heavily (than earlier received metric data) by the scoring definition algorithms used to calculate particular scores and sub-scores, so as to bias the quality score in favor of the most recent release and executing environment characteristics.

Metric data (e.g., 232, 234) can be collected from and generated by a variety of sources. In some instances, users can generate feedback data reporting both functional and non-functional aspects of an application. For instance, functional and non-functional metric data can be received from user devices (e.g., 110, 115). As an example, user feedback data can be in the form of a reported defect, generation of a service ticket, customer satisfaction survey, customer scorecard (e.g., Beta or professional services engagement data), or other form of feedback data. Such metric data can be further mapped to particular deployments or instances of an application, based on the user, user device, or network from which the user feedback data originates.

Metric data (e.g., 232-234) can also be generated by computing systems and computer-driven tools, such as tools monitoring the applications (e.g., 246, 248) for which the quality scores are to be generated. In one example, some applications (e.g., 248) may be provisioned with an agent (e.g., 250) or other local monitor, which can assess and capture attributes of the application's deployment, operation, and use by a particular customer on a corresponding system. Applications (e.g., 246, 248) can be hosted by one or more application server systems (e.g., 120, 125). Application server systems (e.g., 120, 125) can include one or more data processing apparatus (e.g., 238, 240) and one or more memory elements (e.g., 242, 244), the processors (e.g., 238, 240) capable of executing code of the hosted application (e.g., 246, 248) as well as the code of any locally hosted agents or application monitors (e.g., 250). Such tools (e.g., 250) can generate data reporting their observations and the reporting data can be provided to a quality assessment system 105 as metric data (e.g., 232, 234). Performance monitors (e.g., 205) can also be provided remote from the systems (e.g., 120, 125) hosting the applications being monitored. For instance, a performance monitor 205 can be provided including one or more data processors (e.g., 252) and one or more memory elements (e.g., 254), and one or more performance engines (e.g., 255) implemented in hardware and/or software to interact with (e.g., over network 245) and perform monitoring of one or more applications (e.g., 246, 248). Monitoring results generated by the performance monitor 205 can reflect aspects of the application observed during the performance monitoring. For instance, functional attributes such as application errors can be observed and reported, as well as non-functional attributes such as the number of help functions called by users, reinstalls performed by users, the amount of time spent performing particular transactions by users, overall system uptime, time from start of install/upgrade to completion, mean time to resolution of detected defects, among other examples. The results of the monitoring can be embodied in monitor data 256, which can be shared by the performance monitor 205 with quality assessment system 105 for adoption as metric data (e.g., 232, 234) to be utilized in the generation of corresponding quality scores and sub-scores.

In some cases, non-functional aspects of an application (e.g., 246, 248) can be described in documentation and other sources (e.g., 280), such as design-time aspects of the application. One or more data sources (e.g., 210) can be queried or otherwise accessed by the quality assessment system 105 (e.g., using a data collection module 230)) that host electronic documents 280 relevant to aspects of an application (e.g., 246, 248) of interest to the quality assessment system 105. In one example, data collection module 230 can include functionality to scrape or crawl various documents (e.g., 280) to identify documents relevant to a particular application and capture text data from the identified documents. Data collection module 230 can further include natural language processing and other functionality to detect terms in the documents 280 that relate to one or more aspects (and aspect values) considered in corresponding scoring definitions (e.g., 236) and can generate corresponding metric data (e.g., 232, 234) from the documents 280. Metric data can be generated from multiple different user and machine-provided sources. For example, in some instances, multiple data sources (e.g., 280) can be queried and used to obtain metric data from which quality scores can be generated. In one example, a data source 210 can include one or more processors 274, one or more memory elements 276, an interface 278 (e.g., an application programming interface) through which the quality assessment system 105 and/or other tools can access documents 280 and other data, among other example features and components.

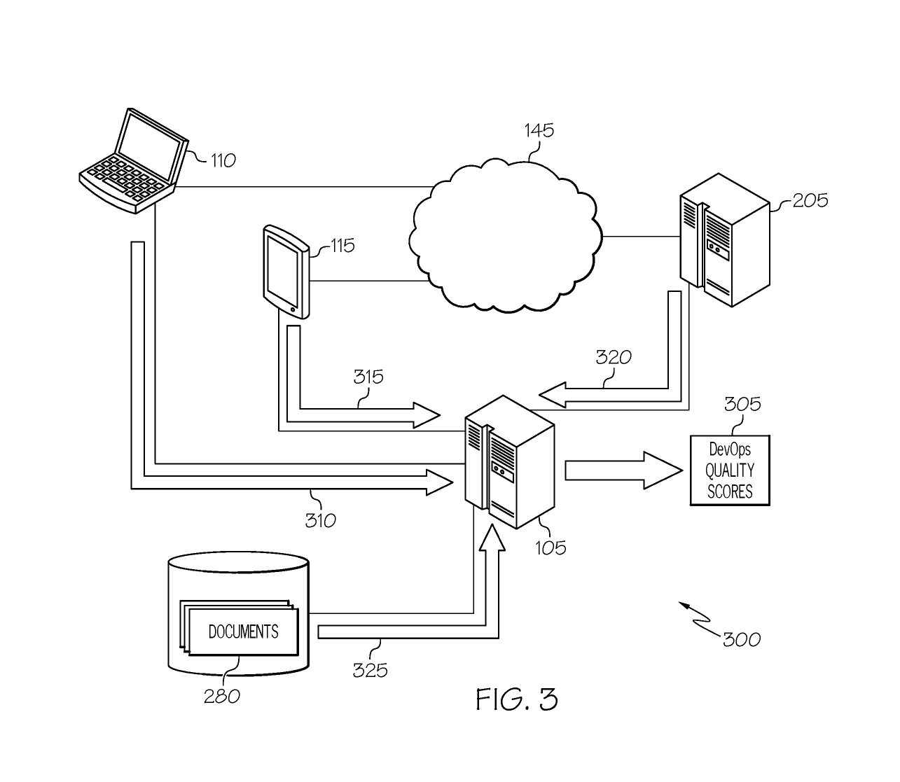

Turning to FIG. 3, a simplified block diagram 300 is shown illustrating the generation of an example quality score 305 in the context of DevOps for a particular application. As noted above, metric data can be obtained from a variety of different sources. User feedback data 310, 315 can be generated at user devices 110, 115, and be reported to convey functional and non-functional aspects of an application (e.g., hosted by application server 120). These user inputs can be supplemented with performance metric data 320 indicating aspects of the application as captured by computerized monitoring (e.g., at 205) of the application. Additionally, text data can be obtained by scanning electronic documents 280 to generate additional metric data 325, for instance, from design-time, promotional, user instructions, or other documentation 280 pertaining to the application. The values of the metric data (e.g., 310, 315, 320, 325) can be input into sub-score definitions to determine one or more sub-scores relating to functional and non-functional aspects of the application. These sub-scores can be used (potentially with still further metric data) to generate an overall quality score (e.g., 305) for the application, according to a scoring definition for the application (and/or application instance or customer).

A diverse number of functional and non-functional metrics can be considered by a quality assessment system in deriving quality scores for one or more applications. GUIs generated to illustrate the scores can also reflect values of these metrics. Some of these metrics can be application- or customer-specific. Table 1 outlines some example metrics, which can be referenced and utilized in algorithms of scoring definitions utilized by an example implementation of a quality assessment system:

TABLE 1
Quality Metric Examples

| Metric | Type | Description | Sub-Score |
|---|---|---|---|
| Open support items | Functional | All open support issues, | Support Issues |
| by severity | | organized by severity | |
| Open support items | Functional | All open support issues, | Support Issues |
| by type | | organized by severity | |
| Open support items | Functional | All open support issues, | Support Issues |
| by release | | organized by Release | |
| Defects (severity 1) | Functional | All open S1 defects against the | Defects |
| | | current release under | |
| | | development | |
| Defects (severity 2) | Functional | All open S2 defects against the | Defects |
| | | current release under | |
| | | development | |
| Defects (severity 3) | Functional | All open S3 defects against the | Defects |
| | | current release under | |
| | | development | |
| Defects (severity 4) | Functional | All open S4 defects against the | Defects |
| | | current release under | |
| | | development | |
| Defect point of | Functional | All open defects, organized by | Defects |
| origin | | Originator (i.e. SWAT, External | |
| | | Customer, Internal Customer, | |
| | | etc.) | |
| Defect Density | Functional | The number of confirmed | Correctness |
| | | defects detected in the product | |
| | | during a release under | |
| | | development divided by the | |
| | | size of the product. This | |
| | | number should increase at a | |
| | | steady rate throughout the | |
| | | release cycle and level off | |
| | | toward the release date | |
| Escaped Defect | Functional | The number of confirmed | Correctness |
| Density | | defects reported by customers | |
| | | per 1000 lines of source in a GA | |
| | | release | |
| Code Coverage | Functional | Percentage of classes executed | Correctness |
| (Class) | | by all tests | |
| Code Coverage | Functional | Percentage of methods | Correctness |
| (Method) | | executed by all tests | |
| Code Coverage | Functional | Percentage of lines executed by | Correctness |
| (Line) | | all tests | |
| Test Automation % | Functional | Number of testplans that are | Correctness |
| | | automated (by any method of | |
| | | automation) | |
| Product Build | Functional | Number of automated tests | Correctness |
| Quality | | that are passing divided by the | |
| | | total number of automated | |
| | | tests | |
| New Install | Non-functional | The time it takes to install, | Implementability |
| | | configure with a database (not | |
| | | Derby) and successfully run the | |
| | | examples against the demo | |
| | | server | |
| Upgrade | Non-functional | The time it takes to upgrade, | Implementability |
| | | configure with a database (not | |
| | | Derby) and successfully run the | |
| | | examples against the demo | |
| | | server. | |
| Volatility | Non-functional | Number of items (stories, tasks, | Readiness |
| | | defects) that have >=3 changes | |
| | | to the description and | |
| | | acceptance criteria (in total) | |
| | | once they are assigned to an | |
| | | iteration backlog divided by the | |
| | | total number of issues in the | |
| | | iteration backlog | |
| Completeness | Non-functional | The number of all issues in an | Readiness |
| | | iteration backlog that have met | |
| | | the Definition of Ready divided | |
| | | by the number of issues in the | |
| | | iteration backlog | |
| System Usability | Non-functional | Usability testing allowing a | Usability |
| Scale (SuS) Scoring | | design team to evaluate a | |
| | | product's user experience by | |
| | | observing a group of | |
| | | representative users | |
| | | performing common tasks with | |
| | | the application | |
| Beta input | Non-functional | Information from the | Usability |
| (anecdotal) | | customers regarding the | |
| | | quality/usefulness/usability of | |
| | | the beta candidate. This is in | |
| | | the form of anecdotal | |
| | | information. | |
| Beta input | Non-functional | Information from the | Usability |
| (scorecards) | | customers regarding the | |
| | | quality/usefulness/usability of | |
| | | the beta candidate. This is in | |
| | | the form of beta scorecards. | |
| Code complexity | Non-functional | Indicator of code complexity | Maintainability |
| (cyclomatic #) | | utilizing the cyclomatic number | |
| Transactions over | Non-functional | Indicator of the throughput of | Performance |
| time | | transactions over a specified | |
| | | period of time and time unit. | |
| | | (e.g., 1000 transactions/sec | |
| | | averaged over a collection | |
| | | period of 1 week). | |
| Consistent | Non-functional | Indicator of through put | Scalability |
| throughput | | degradation at certain times in | |
| | | the day/month/year (e.g., do | |
| | | the transactions per time | |
| | | period slow down at specific | |
| | | intervals, namely when the | |
| | | system is under stress). | |
| Mean Cumulative | Non-functional | This is a plot of time along the | Reliability |
| Function (MCF) | | x-axis and the cumulative count | |
| | | of failures on the y-axis. When | |
| | | a failure occurs for a single | |
| | | system, increment the count up | |
| | | one. Eventually, with more | |
| | | failures, the graph appears like | |
| | | a staircase, sometimes with | |
| | | long or short steps. A failure is | |
| | | considered an error in the log | |
| | | or an overall system failure. | |
| Mean Time to | Non-functional | The average amount of time it | Reliability; |
| Resolution (MTTR) | | takes to fix a defect for a GA | Supportabiity |
| (General | | version of the product. | |
| Availability (GA) | | | |
| Versions) | | | |
| Mean Time | Non-functional | The average time between | Reliability |
| Between Failures | | system or component failures. | |
| (MTBF) (GA | | | |
| Versions) | | | |
| MTTR (Version | Non-functional | The average amount of time it | Reliability |
| under | | takes to fix a defect for a | |
| development) | | version of the product still | |
| | | under development. | |
| MTBF (Version | Non-functional | The average time between | Reliability |
| under | | system or component failure. | |
| development) | | | |
| Open API | Non-functional | Indicator of whether | Extensibility |
| | | customers/end users can | |
| | | extend functionality (e.g., has | |
| | | an Application Programming | |
| | | Interface (API) been created | |
| | | that will allow the user to | |
| | | extend the functionality of the | |
| | | provided system?) | |
| Build Security in | Non-functional | Indicator of software security | Securability |
| Maturity Model | | status and security policy | |
| (BSIMM) Raw Score | | compliance | |

Each metric can have a respective range of numerical values. These values can be normalized and weighted in connection with an algorithm (defined in a scoring definition) used to generate a sub-score and/or quality score for an application release. The values of the sub-scores, in turn, can be provided as inputs (which may also be normalized and weighted) to an algorithm to generate an overall quality score for the application. Sub-scores can include such example categories as defects (reflecting the number, frequency, and trends of observed defects in the functioning of an application), support issues (reflecting the number of support tickets and the resolvability of these support issues relating to issues observed during functioning of the application), correctness (reflecting the number/frequency/severity of defects as reflected in the overall code and what portion of the code is related to these defects), implementability (reflecting the ease (or difficulty) customers have in implementing the application), supportability (reflecting the ability of an application to be correctly operated in production), usability (reflecting the quality of the user experience), maintainability (reflecting the complexity of and ease (or difficulty) in maintaining an application), portability (reflecting the ability of the application to be utilized across diverse platforms), performance (reflecting the efficiency of the application), scalability (representing the ease or difficulty in scaling deployments of the application), reliability (reflecting the percentage of time an application is properly operational), securability (reflecting security of the application), extensibility (reflecting the ability of the application to accommodate future customer-driven developments or growth), upgradability (reflecting the ability to upgrade the application), integratability (reflecting the ease or difficulty in integrating the application within a broader system), and backward compatibility (reflecting the application's compatibility with previous version, legacy systems or files), each based on a respective set of functional and/or non-functional metrics, among other examples. Some sub-scores can be based on the values of other sub-scores and can represent a composite of multiple sub-scores. For instance, an overall product satisfaction score, an overall support satisfaction score, and a continuous delivery maturity model score (reflecting a development team's or organization's maturity with regards to continuous development and delivery benchmarks) can be generated from multiple sub-score values, can be generated, among other examples. As noted above, a scoring definition for an overall quality score can set forth that the combination of all sub-scores be considered as inputs to derive a score reflecting the overall quality of an application in its current state of development, based on both functional and non-functional attributes of the application.

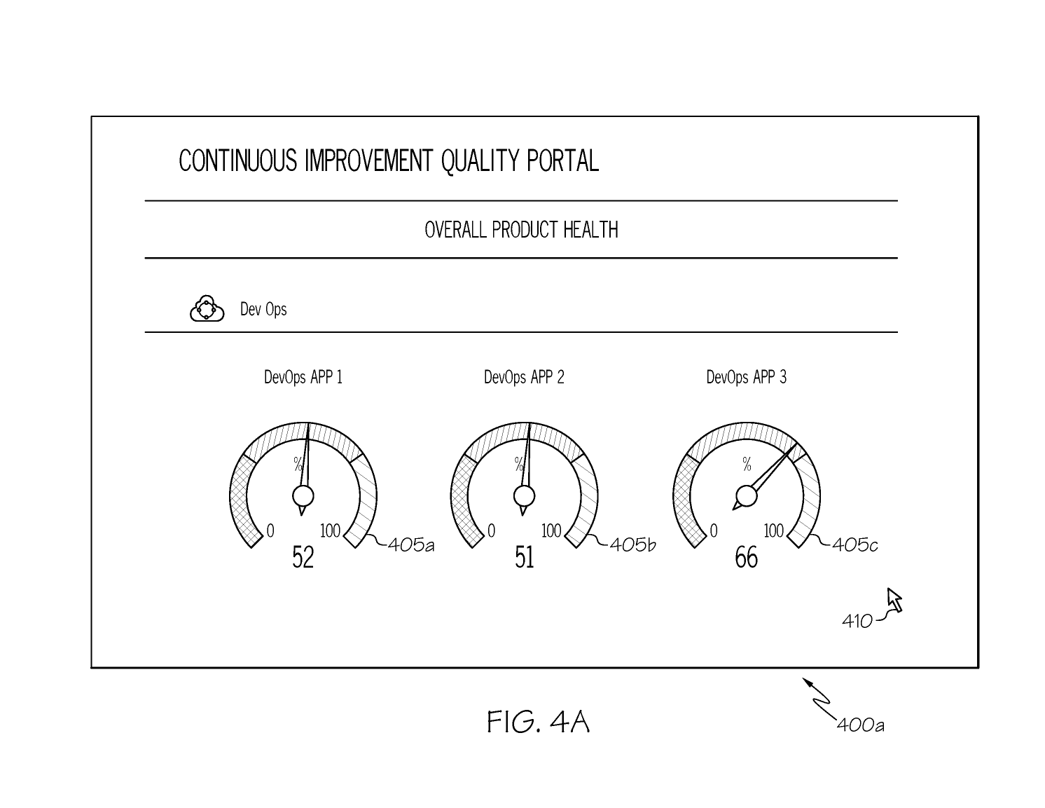

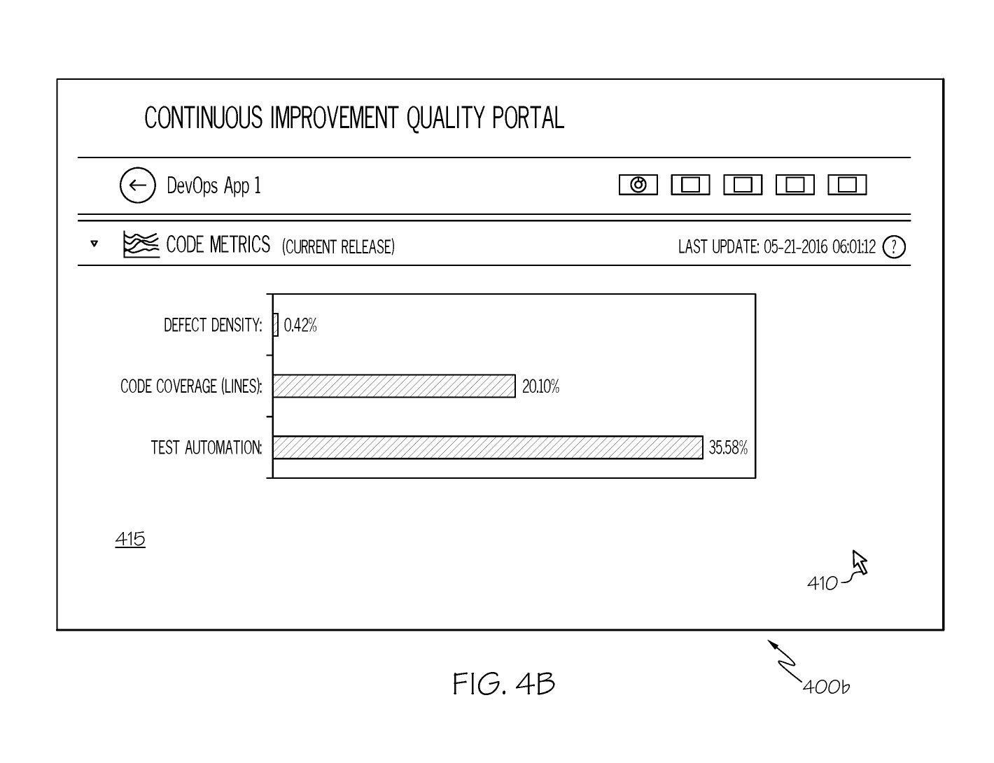

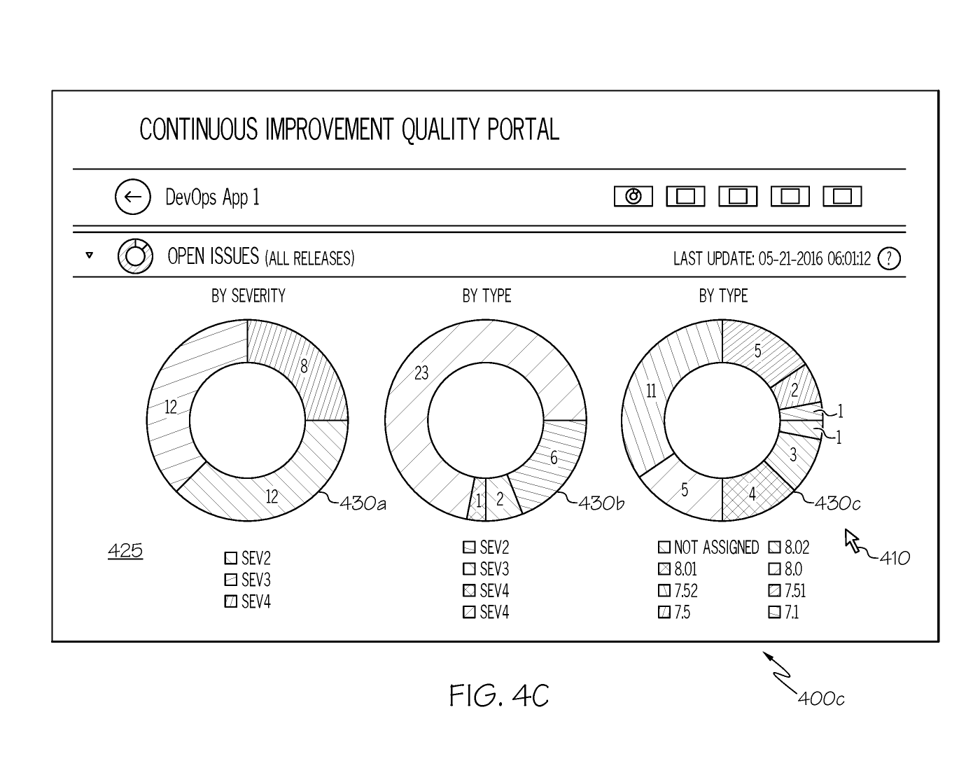

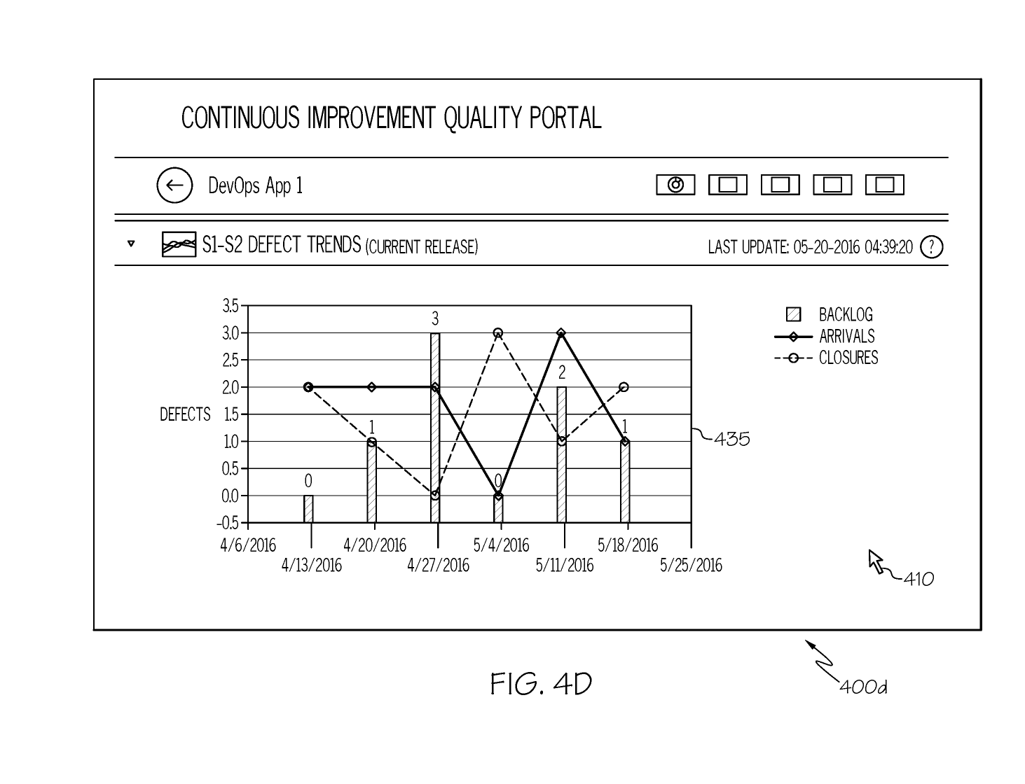

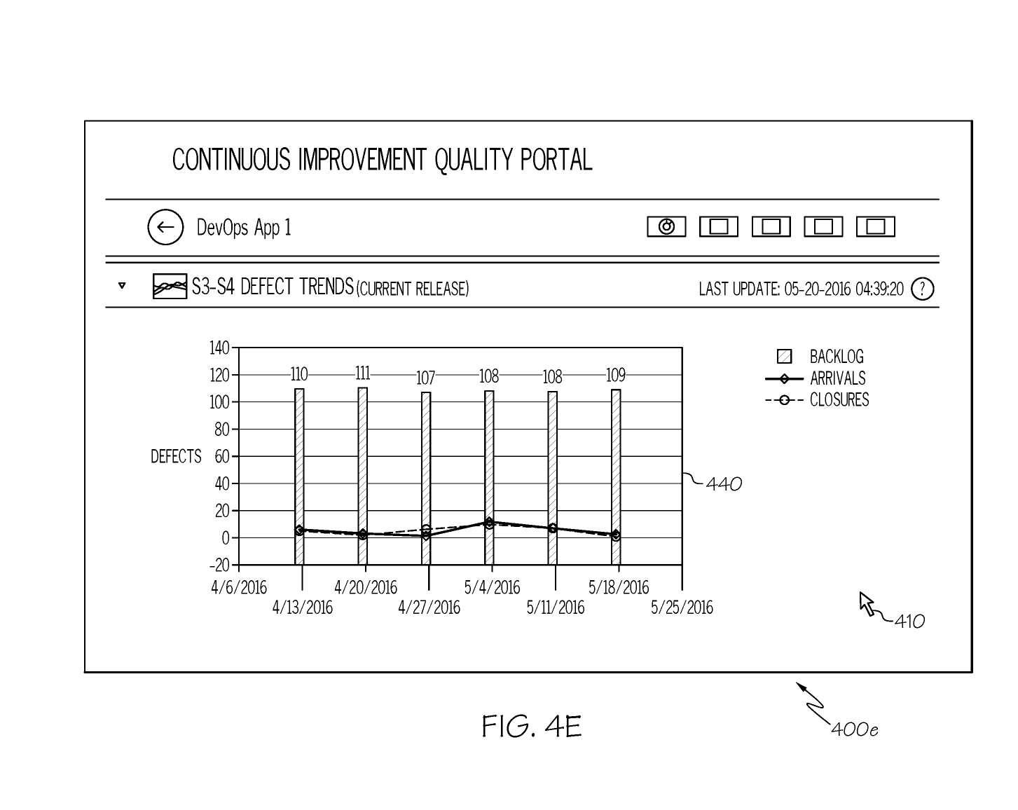

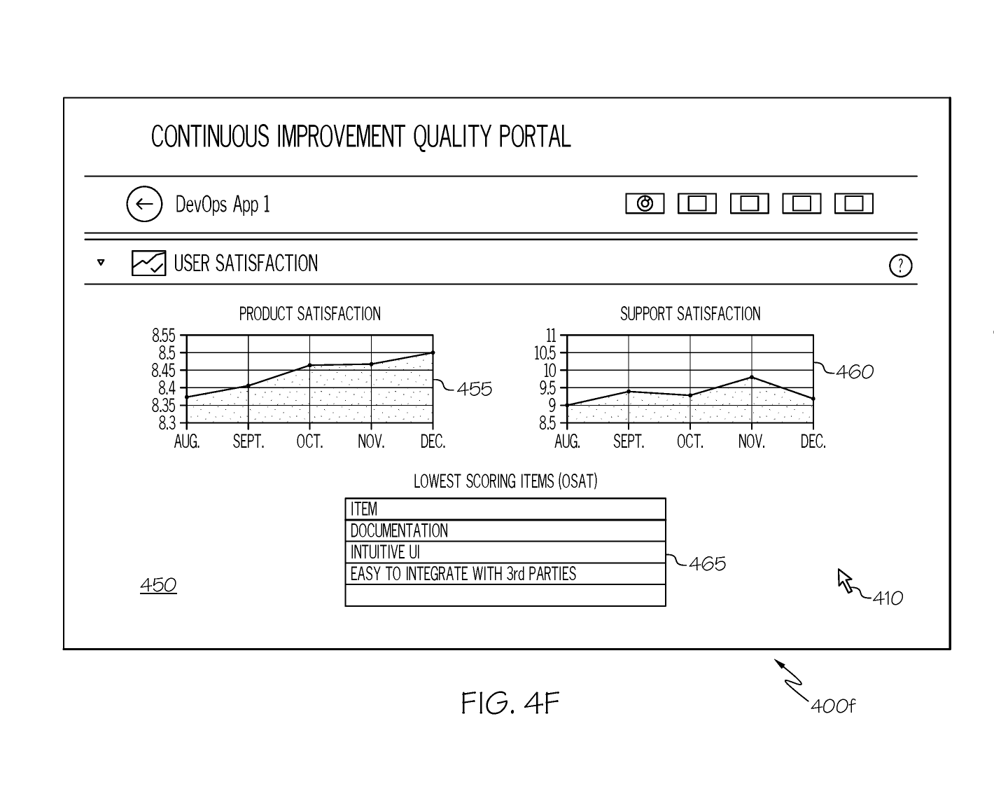

FIGS. 4A-4F are screenshots 400a-f of example GUIs of a dashboard or other presentation illustrating quality scores, sub-scores, key performance indicators (e.g., metric values or sub-score values), and other information reflecting aspects of the quality of an application. The graphical elements of the GUIs can be interactive, allowing users to select elements graphically representing metric, sub-score, or quality score values in order to inspect (and navigate to other GUI presentations representing) further details or alternative views of the data describing quality of a particular application. For instance, turning to the example of FIG. 4A, a GUI window is shown representing “Overall Product Health” for three different applications or software tools. In this example, the applications are each DevOps tools and can pertain to releases across multiple client customer systems. In other examples, different applications (together with their respective quality scores) can be represented in the GUI. Indeed, in one example, a user can select which applications to have presented in the window, by selecting the application from a listing of applications for which quality scores are being calculated and are available to the user (e.g., based on the user being authorized to access the corresponding quality scores and data). In this particular example, three graphical elements 405a-c can be presented, each styled as a dial to represent the value of the overall quality score calculated for each respective application. For instance, dial 405a shows the overall quality score (=52) calculated for a DevOps software tool or application “DevOps App1”, such as a testing, service virtualization, deployment orchestrator, or other tool. Similar quality scores can be generated and presented for additional applications (e.g., “DevOps App2” and “DevOps App3” (at 405b, 405c)). In this particular example, the score is derived as a percentage, or a value within a range of 0-100. In other examples, a different scoring scale could be used.

The dial elements 405a-c can show a real-time quality score for the application, the score (and the dial elements) also capable of changing in real time to reflect the arrival of new metric data and recalculation of the quality score from this metric data. In one implementation, the graphical dial 405a can be color-coded to associate certain score ranges with states of application quality (e.g., scores in a red range indicate low quality, yellow mediocre quality, and green good quality).

A user can interact with the graphical dial elements 405a-c (e.g., using cursor 410), to navigate to additional or modified GUI views illustrating additional details underlying a selected one of the overall quality scores represented by dial elements 405a-c, among other example implementations. For instance, in one example, a user can select dial element 405a and navigate to a different view relating to the example “DevOps App1” application, as shown in the example of FIG. 4B. For instance, a window 415 can be presented which illustrates values of a subset (or all) of the metric values utilized to calculate the overall quality score (e.g., illustrated by the selected dial element 405a). The window 415 can itself include interactive graphical elements (e.g., graph column elements), which can be selected by a user to navigate to additional views. In some cases, interaction with these elements can result in the navigation to GUIs of other systems, such as systems responsible for, relevant to, or providing underlying metric data or even sub-scores, or which may allow a user to perform particular remediation tasks related to particular sub-scores. As another example, in FIG. 4C, the screenshot 400c illustrates a window 425 including a graphical representation breaking down values of an open issue metric utilized in the calculation of the overall quality score for the example “DevOps App1” application. For instance, issues or defects can be represented in graphs 430a-c, breaking down the defects considered in the quality assessment score by severity, type, release, etc. Sections of each of the graphs (e.g., one corresponding to “Answer-Available” issues (for which a solution is known)) can likewise be selected to present a window listing each of the detected issues falling within this designation, allowing a user to review what issues or defects have fallen within this category (as can be done for each of the segments of graphs 430a-c).

Turning to FIG. 4D, another example is illustrated of a higher detail view of metric values used within a quality score (by a quality assessment system). In this example, an interactive defect trend graph 435 showing the amount of backlogged (e.g., unresolved) issues or defects (with a severity of S1 or S2) detected against an axis of time (e.g., the number of defects detected per week), charted against the arrival of newly detected defects and the closure (or resolution) of defects against time. Similarly, FIG. 4E shows a similar graph 440 charting defects of a lower severity (e.g., of severity S3 or S4). As with the example of FIG. 4C, the elements in graphs 435, 440 can be interactive and selection of a corresponding element can allow a user to navigate to additional views of the data or tool-specific GUIs breaking down the individual defects represented by each of the data points (e.g., a listing of the defects closed the week of May 11, 2015, etc.), among other features.

Turning to the example of FIG. 4F, another example view of quality assessment data used by a quality assessment system to generate quality scores for software applications (e.g., under continuous delivery) is shown. In this example, a GUI window 450 is shown illustrating another view of quality assessment data of an application (e.g., an example “DevOps App1” application). As in the examples of FIGS. 4B-4E, the window illustrated in the example of FIG. 4F can be navigated to from or beginning with a GUI presentation of an overall quality score for the application, as represented in FIG. 4A. In this example, graphical elements 455, 460 illustrate a summary of sub-score values (e.g., Product Satisfaction and Support Satisfaction) over time and graphical element 465 illustrates metrics whose low values had the most negative contribution to the overall quality score for the example application. These elements 455, 460, 465 can likewise be interactive enabling navigation to additional detailed views representing the underlying metric data at smaller levels of granularity.

It should be appreciated that the example GUI screenshots 400a-f shown in FIGS. 4A-4F are non-limiting examples provided for illustrating more general principles described herein. Indeed, additional alternative view and graphical representations can be provided to represent quality scores generated by a quality assessment system, as well as underlying sub-scores and metric data upon which the quality scores are based. Further, such scores can be provided for a variety of different applications, including application undergoing continuous development, as well as those for which development is effectively complete. Still further, while certain example metrics and sub-scores have been described, it should be appreciated that still other examples can be provided and utilized to generate a comprehensive quality score for a software application or service, among other examples and considerations.

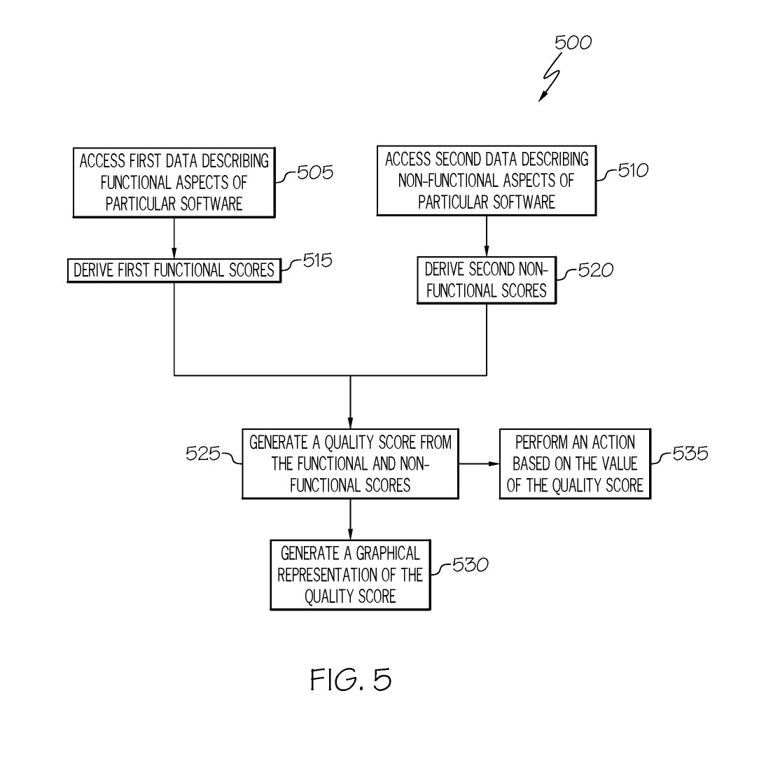

FIG. 5 is a simplified flowchart 500 illustrating an example technique for generating a quality score for a software application. First metric data can be accessed 505 describing functional aspects of the software application. The first metric data can be accessed 505 from multiple different sources, including users and other computer systems. Second metric data can be accessed 510 describing non-functional aspects of the software application. The second metric data can also originate from multiple different sources. Accessing metric data can include receiving the metric data from its respective source, generating the metric data (e.g., from a scan of an electronic document, user feedback survey, etc.), pulling the data from a data source, among other techniques. Functional scores can be derived 515 from the first data. This can include deriving a numerical score to correspond to functional aspects described in the first data. Similarly, numerical scores can be derived 520 to quantify non-functional aspects described in the second data. In some implementations, one or more sub-scores can be generated from these functional and non-functional scores. The scores can also be used to generate 525 a quality score for the particular software application. A graphical representation of the quality score can be generated 530 to provide an interactive user interface through which users can navigate to additional graphical views of the underlying scores and data used to generate the quality score. Further, in some cases, the value of the quality score can cause an action to be triggered 535, such as an alert, a service ticket, or other action, to prompt an administrator to take action to assess the cause of a drop in application quality and begin resolution of the underlying issue, among other example uses.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing first data describing a plurality of different functional aspects of a particular software application, wherein the first data is received from a first plurality of sources;
accessing second data describing a plurality of different non-functional aspects of the particular software application, wherein the second data is received from a second plurality of sources;
deriving a plurality of functional scores for the particular software application based on the plurality of functional aspects;
deriving a plurality of non-functional scores for the particular software application based on the plurality of non-functional aspects; and
calculating a quality score for the particular software application from the plurality of functional scores and the plurality of non-functional scores.

2. The method of claim 1, wherein the first data comprises user data generated from a user input reporting a particular one of the plurality of different functional aspects.

3. The method of claim 2, wherein the first data comprises a defect report.

4. The method of claim 1, wherein the first data comprises data generated by an automated scan of the particular software application reporting a particular one of the plurality of different functional aspects.

5. The method of claim 1, wherein the first data comprises user data generated from a user input reporting a particular one of the plurality of different non-functional aspects.

6. The method of claim 1, wherein the second data comprises data obtained through a scan of a set of electronic documents describing the particular software application.

7. The method of claim 1, further comprising generating graphical user interface (GUI) data for rendering by a display device to present an interactive graphical representation of the quality score, wherein user interactions with the graphical representation cause views of at least one of the non-functional score and functional score to be presented.

8. The method of claim 7, wherein the particular application is one of a plurality of applications for which a respective quality score is generated from respective functional and non-functional aspects of the corresponding application, and the graphical representation comprises representations of the quality scores for each of the plurality of applications.

9. The method of claim 1, wherein the non-functional aspects comprise a subjective assessment of quality of support provided for the particular software application.

10. The method of claim 1, further comprising:
determining whether the quality score is below a particular threshold value; and
triggering a particular event when the quality score falls below the particular threshold value.

11. The method of claim 1, wherein the particular application is an application under continuous delivery development.

12. The method of claim 11, further comprising generating a continuous delivery continuous delivery maturity score for a particular development team corresponding to the particular software application based on at least a portion of the plurality of functional scores and at least a portion of the plurality of non-functional scores.

13. The method of claim 1, wherein the functional aspects comprise aspects describing whether the particular application functions correctly.

14. The method of claim 13, wherein the non-functional aspects pertain to aspects of the particular application observable when the particular application is not in operation.

15. The method of claim 1, wherein the plurality of non-functional scores comprise an implementability score, a readiness score, a usability score, and a reliability score.

16. The method of claim 1, wherein a particular one of the non-functional scores is based on two or more values in the second data and the two or more values comprises values corresponding to two or more non-functional aspects of the particular application.

17. A computer program product comprising a computer readable storage medium comprising computer readable program code embodied therewith, the computer readable program code comprising:
computer readable program code configured to access a first data set describing a plurality of different functional aspects of a particular software application, wherein the functional aspects comprise aspects relating to whether the particular application functions correctly;
computer readable program code configured to access a second data set describing a plurality of different non-functional aspects of the particular software application, wherein the non-functional aspects comprise aspects relating to ease of deployment and usability of the particular software application;
computer readable program code configured to identify a scoring definition corresponding to the particular software application; and
computer readable program code configured to calculate a quality score for the particular software application from values of the first data set and second data provided as inputs to an algorithm defined in the scoring definition.

18. A system comprising:
a data processing apparatus;
a memory device; and
a quality assessment system executable by the data processing apparatus to:
access first data describing a plurality of different functional aspects of a particular software application, wherein the first data is received from a first plurality of sources;
access second data describing a plurality of different non-functional aspects of the particular software application, wherein the second data is received from a second plurality of sources;
derive a plurality of functional scores for the particular software application based on the plurality of functional aspects;
derive a plurality of non-functional scores for the particular software application based on the plurality of non-functional aspects; and
calculate a quality score for the particular software application from the plurality of functional scores and the plurality of non-functional scores.

19. The system of claim 18, further comprising a data crawler to scan the second plurality of sources to identify documentation related to non-functional aspects of the particular software application.

20. The system of claim 18, further comprising a performance monitor executable to detect a particular one of the functional aspects and generate a portion of the first data.
